(19) United States
(12) Patent Application Publication
(10) Pub. No.: US 2022/0279982 A1
(43) Pub. Date: Sep. 8, 2022

(54) Cutting Board to Cooler Lid Securing System

(71) Applicant: PECOS USA, LLC, Austin, TX (US)

(72) Inventors: Frederick Gowen Scheen, Austin, TX (US); Matthew Robert Maasdam, Ann Arbor, MI (US); Creath Davis Smitham, Austin, TX (US)

(73) Assignee: PECOS USA, LLC, Austin, TX (US)

(21) Appl. No.: 17/192,586

(22) Filed: Mar. 4, 2021

(51) Int. Cl. A47J 47/00; B65D 51/24; F25D 3/08; H01F 7/02

(52) U.S. Cl. CPC A47J 47/005; B65D 51/24; F25D 3/08; H01F 7/02

(57) ABSTRACT

A cutting board to cooler lid securing system is described. A cutting board includes a cutting surface and a bottom surface that includes at least two cavities. Each cavity of the at least two cavities has one or more embedded magnets and is configured to receive a magnetic protrusion of at least two magnetic protrusions mounted to a lid of a cooler. The at least two cavities and the at least two magnetic protrusions form a securing system to mechanically and magnetically secure the cutting board to the cooler.

### BACKGROUND

When camping, boating, tailgating, barbequing, fishing, or hunting, users often need to find a flat surface to prepare food and drinks, filet fish, and so forth. As these types of activities occur outdoors, the options for a flat surface can be limited. As such, a user may resort to using a cooler as a “pseudo table” for food or drink preparation. Unfortunately, using the lid of a cooler for cutting often results in damage to the cooler itself, e.g., cuts and scratches to the cooler, blood stains, and so forth. Today, users are increasingly purchasing coolers that are manufactured using rotomolded polyethelene. While such coolers typically do a better job at keeping things colder for longer durations, these rotomolded polyethelene coolers are also much more expensive than conventional coolers. As such, many users are now reluctant to use coolers for cutting or food and drink preparation due to the potential damage to the cooler which may result in an undesirable appearance and loss of value.

### SUMMARY

To overcome these problems, a cutting board to cooler lid securing system may be deployed. A cutting board includes a cutting surface and a bottom surface that includes at least two cavities. Each cavity of the at least two cavities has one or more embedded magnets and is configured to receive a magnetic protrusion of at least two magnetic protrusions mounted to a lid of a cooler. The at least two cavities and the at least two magnetic protrusions form a securing system to mechanically and magnetically secure the cutting board to the cooler.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of a cutting board and a securing system to secure the cutting board to a cooler lid.

FIG. 2 depicts a magnetic coupling to magnetically secure the cutting board to the cooler lid.

FIG. 3 depicts the cutting board, a surface to which the cutting board may be secured with the securing system, and axes around which the securing system mechanically prevents the cutting board from rotating.

FIG. 4 depicts the cutting board, the surface to which the cutting board may be secured with the securing system, and axes along which the securing system mechanically prevents the cutting board from shifting.

FIG. 5 depicts the cutting board and the surface to which the cutting board may be secured with the securing system in different views, including views depicting that the cutting board occludes the securing system when secured to the surface.

FIG. 6 depicts a scenario in which protrusions of the securing system are mounted to a surface to which the securing system is configured to secure the cutting board.

FIG. 7 depicts the cutting board secured via a securing system to a different surface from a cooler lid.

FIG. 8 depicts examples of implementations in which the securing system has different numbers of protrusions and cavities.

FIG. 9 depicts a procedure in an example implementation in which magnetic protrusions of the securing system are mounted to a lid of a cooler to enable the cutting board to be magnetically and mechanically secured to the lid of the cooler.

### DETAILED DESCRIPTION

Overview

A cutting board to cooler lid securing system is described herein. The securing system enables a cutting board to be removably secured to a flat surface, such as the lid of a cooler. When secured to the lid of the cooler via the securing system, the cutting board enables users to prepare food or drink, cut up fish, and so forth on the cutting board instead of the lid of the cooler thereby preventing damage to the cooler itself. When the cutting board is secured, the cooler can still be opened and closed, and thus the cooler with the cutting board secured can still be used for its intended function. When the user is finished with tasks such as food preparation, the cutting board can be easily detached from the lid of the cooler.

Generally, the securing system includes a first securing portion that is positioned on a bottom surface of the cutting board and a second securing portion that is positioned on the lid of the cooler. The first securing portion and the second securing portion act in concert to secure the cutting board to the lid of the cooler using both magnetic and mechanical forces. In one or more implementations, the securing system includes at least two magnetic protrusions and at least two cavities which are configured to receive the magnetic protrusions. Each of the magnetic protrusions includes one or more embedded magnets. The magnetic protrusions, cavities, and magnets embedded in the cavities form a securing system to secure the cutting board to the lid of a cooler, or any other separate object with a flat surface.

In one or more implementations, the cavities and embedded magnets form the first securing portion and are positioned on a bottom surface of the cutting board, while the magnetic protrusions form the second securing portion and are mounted to the lid of the cooler. Broadly speaking, the magnets and the magnetic protrusions magnetically secure the cutting board to the lid of the cooler, e.g., using complementary magnetic force. By contrast, the cavities and the magnetic protrusions mechanically secure the cutting board to the lid of the cooler. By utilizing both mechanical and magnetic forces to secure the cutting board to the cooler, the securing system enables the cutting board to be secured to the cooler while the user is cutting on the cutting board, but also removed relatively easily by a user without the use of tools. At the same time, the mechanical and magnetic forces prevent the cutting board from becoming detached from the lid unintentionally, such as in the event that the cutting board is secured to the lid of the cooler in the back of a moving boat.

In the following discussion, an example securing system is described by way of example as being configured to secure a cutting board to a lid of a cooler. However, it should be readily apparent that the following discussion is not limited to a cutting board or a cooler. The securing system may be used to magnetically and mechanically secure a variety of objects (e.g., accessories) to separate objects without departing from the spirit or scope of the described techniques.

Accessory Securing System

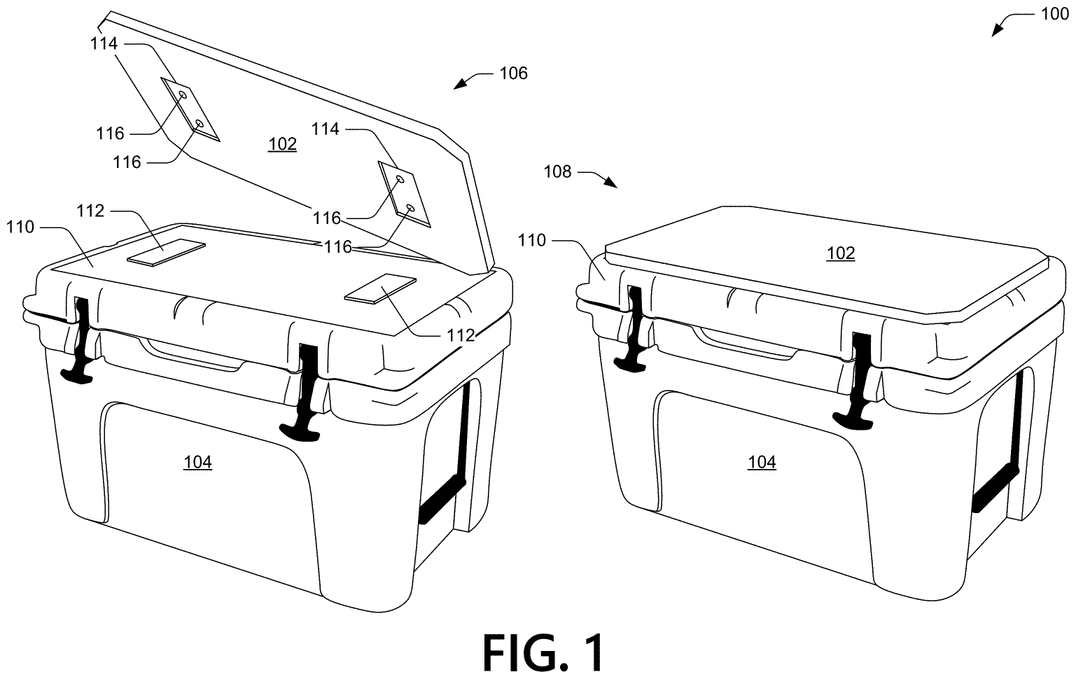

FIG. 1 is an illustration of an example 100 implementation of a cutting board and a securing system to secure the cutting board to a cooler lid. The illustrated example 100 includes a cutting board 102 and a cooler 104.

In particular, the illustrated example 100 depicts the cutting board 102 and the cooler 104 at a first stage 106 and a second stage 108. At the first stage 106, the cutting board 102 is depicted detached from the cooler 104. With the cutting board 102 detached and lifted away from a lid 110 of the cooler 104, magnetic protrusions 112 and cavities 114 are visible. The magnetic protrusions 112, the cavities 114, and magnets 116 embedded in the cavities 114 form a securing system to secure the cutting board 102 to the lid 110 of the cooler 104.

Broadly speaking, the magnets 116 and the magnetic protrusions 112 magnetically secure the cutting board 102 to the lid 110 of the cooler 104, e.g., based on complementary magnetic force. By contrast, the cavities 114 and the magnetic protrusions 112 mechanically secure the cutting board 102 to the lid 110 of the cooler 104. Generally, the cavities 114 each correspond to an unfilled space on a surface, e.g., the bottom surface of the cutting board 102. When the magnetic protrusions 112 are disposed in the unfilled space of the cavities 114, for instance, the magnetic protrusions 112 are configured to physically contact (e.g., responsive to a force to shift the cutting board 102 or the lid 110 relative one to another) a surface of the cavities 114, preventing movement of the cutting board 102. By way of example, the unfilled space of the cavities 114 create “walls” within the bottom surface of the cutting board 102 and the magnetic protrusions 112 may contact one or more of these walls of the cavities 114, such that the contact prevents lateral movement of the cutting board 102 and the lid 110 of the cooler 104 relative one to another. Notably, a depth of each of the cavities 114 may vary.

At the second stage 108, the cutting board 102 is depicted as secured to the lid 110 of the cooler 104. The securing system is configured such that when the cutting board 102 is secured to a surface (e.g., the lid 110 of the cooler 104), the securing system is hidden from view (e.g., not visible). In other words, the cutting board 102 occludes the magnetic protrusions 112, the cavities 114, and the magnets 116 embedded within the cavities 114 when secured to a surface.

In one or more implementations, the magnetic protrusions 112 may be mounted to the lid 110 of the cooler 104 using an adhesive. The adhesive may be applied to a mounting-surface side of the magnetic protrusions 112. Prior to mounting the magnetic protrusions 112 to the lid 110 of the cooler 104, for example, the adhesive may be covered with a film to prevent the magnetic protrusions 112 from being mounted to other surfaces unintentionally. After the film is removed from the adhesive (e.g., peeled off the adhesive), the mounting-surface side of the magnetic protrusions 112 having the adhesive may be pressed against the lid 110 of the cooler 104. The adhesive selected for the magnetic protrusions 112 is configured to form a bond with a surface (e.g., the lid 110 of the cooler 104) that is suitable to mount the magnetic protrusions 112 to the surface. Moreover, the adhesive selected for this application is configured to form a bond with the surface that is strong enough to resist detachment of the magnetic protrusions 112 from the surface—due to a magnetic coupling between the magnetic protrusions 112 and the magnets 116—when the cutting board 102 is pulled away from the surface. In other words, the bond of the adhesive to the surface is stronger than the complementary magnetic force forming the magnetic coupling between the magnetic protrusions 112 and the magnets 116. This enables the cutting board 102 to be removed (e.g., pulled off) of the lid 110 of the cooler 104 without removing the magnetic protrusions 112 from the lid 110—the magnetic protrusions 112 are configured to remain mounted on the lid 110 after the adhesive bonds to mount the magnetic protrusions 112 to the lid 110.

In general, the selected adhesive that is applied to the magnetic protrusions 112 to enable them to be mounted to a surface may create a bond that makes detaching the magnetic protrusions 112 from the surface relatively difficult. For example, such a bond may require a user to use tools or chemicals (e.g., solvents) to remove the magnetic protrusions 112 from a surface to which the magnetic protrusions 112 have been mounted. It is to be appreciated that the magnetic protrusions 112 may be mounted to a surface in other ways without departing from the spirit or scope of the techniques described herein, such as by using fasteners (e.g., screws), welding them, or using some combination of mounting techniques and/or products.

It is to be appreciated that the securing system may be configured differently than illustrated in one or more implementations. For example, in the illustrated example 100 the securing system is depicted with two magnetic protrusions 112, two cavities 114 and two magnets 116 for each cavity 114. It is to be appreciated, however, that the number and positioning of magnetic protrusions 112, cavities 114, and/or magnets 116 can be varied without departing from the spirit or scope of the described techniques. In one or more implementations, for example, the securing system may be configured with four cavities 114 which are positioned at each corner of the cutting board 102 and configured to receive four magnetic protrusions 112. Moreover, while depicted with two magnets 116 for each cavity 114, the number and types of magnets 116 in the cavities 114 can also vary without departing from the spirit or scope of the described techniques. For example, in one or more implementations, each cavity 114 may include just a single magnet 116. Alternately or additionally, the magnetic protrusions 112 may include one or more magnets 116. In one or more implementations, the placement of the magnetic protrusions and cavities of the securing system may be reversed, such that the cavities 114 and embedded magnets 116 are positioned on the lid of the cooler 104 while the magnetic protrusions 112 are positioned on the bottom surface of the cutting board 102.

Notably, the securing system can be usable with coolers which are sized to the precise dimensions of the cutting board, but can also be used to secure the cutting board to smaller or larger surfaces. In this way, the cutting board can be utilized with a variety of different types and sizes of coolers, as well as with other flat surfaces such as a truck tailgate, a flat surface of a boat, and so forth. Moreover, as discussed above and below, the securing system may be configured to secure a variety of different types of accessories in addition to a cutting board, such as a seat cushion, a table top (e.g., a card table top or desk surface), a beer koozie or other beverage holder, a second (e.g., smaller) cooler, or another container (e.g., a picnic basket, toolbox, or storage container), to name just a few.

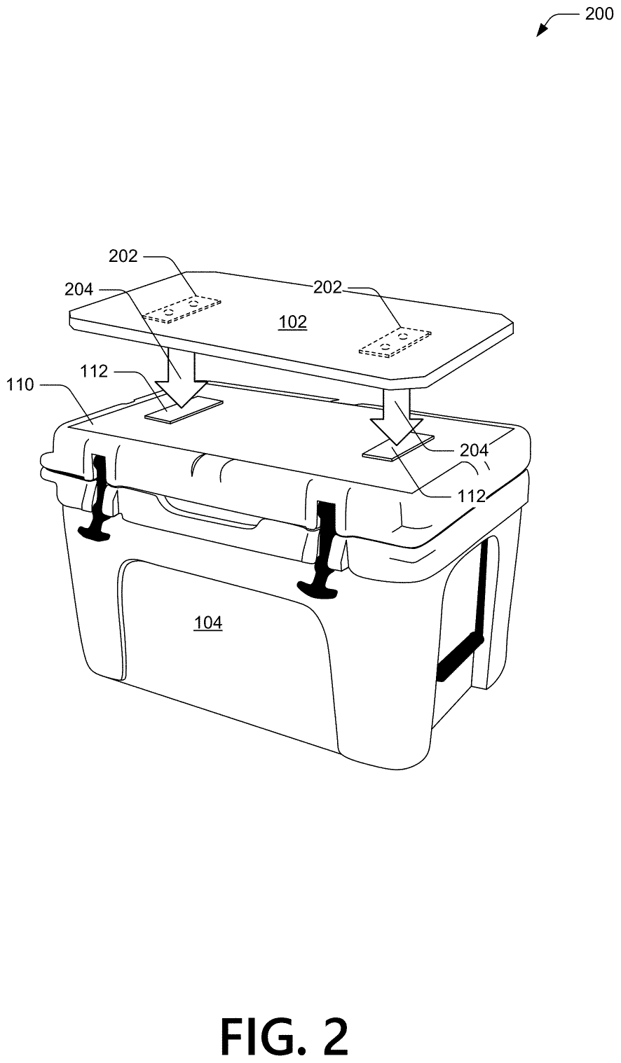

FIG. 2 depicts an example 200 of a magnetic coupling to magnetically secure the cutting board to the cooler lid.

The illustrated example 200 includes from FIG. 1, the cutting board 102 and the cooler 104. In the view depicted in this example 200, the magnetic protrusions 112 of the securing system are visible. The cavities 114 and the magnets 116 are not visible in this view because they are occluded from view by a cutting surface of the cutting board 102. In accordance with the described techniques, the cavities 114 and the magnets 116 are disposed on a bottom surface of the cutting board 102, i.e., a surface of the cutting board 102 that contacts the lid 110 of the cooler 104 when the cutting board 102 is secured to the lid 110 of the cooler 104 by the securing system. Here, a relative position of the cavities 114 and the magnets 116 on the bottom surface of the cutting board 102 is represented by dashed lines 202.

The illustrated example 200 also includes representations 204 of magnetic force. In particular, the representations 204 represent a magnetic force of the magnets 116, e.g., a force of the magnets 116 configured to pull the magnets 116 against the magnetic protrusions 112. In accordance with the described techniques, the magnets 116 and the magnetic protrusions 112 have complementary magnetic force such that the force pulls the magnets 116 and the magnetic protrusions 112 together. In other words, this complementary magnetic force “attracts” the magnetic protrusions 112 and the magnets 116 together. Further, this magnetism is effective to form a magnetic coupling between the magnetic protrusions 112 and the magnets 116, and the magnetic coupling magnetically secures the cutting board 102 against the lid 110 of the cooler 104. In one or more implementations, the magnetic protrusions 112 may not include magnets. Instead, the magnetic protrusions 112 may be formed of or otherwise include a material with which the magnets 116 in the cavities 114 can form a magnetic coupling, e.g., iron, cobalt, nickel, and steel, to name just a few. Alternatively, the magnetic protrusions 112 may each include one or more magnets. In implementations where the magnetic protrusions 112 do include magnets, the magnetic protrusions 112 also may be formed of a material with which the magnets 116 in the cavities 114 can form a magnetic coupling or may be formed from some other material, e.g., plastic.

In accordance with the described techniques, the magnetic force represented by the representations 204 secures the cutting board 102 to the lid 110 of the cooler 104 in a direction that is parallel to a vertical axis (not shown) of the cooler 104. The direction in which the cutting board 102 is generally secured magnetically to the lid 110 is also substantially orthogonal to a first plane defined by the lid 110's surface and to a second plane defined by the cutting board 102's bottom surface. When the cutting board 102 is secured to the lid 110, the first and second planes defined by those surfaces are substantially parallel. In operation, the magnetic protrusions 112 and the magnets 116 are configured to draw the bottom surface of cutting board 102 and the surface of the lid 110 together.

In order to remove the cutting board 102, a force in an opposite direction to the magnetic force represented by the representations 204 must be applied to the cutting board 102 to pull the cutting board 102 away from the lid 110 of the cooler 104. This force must be sufficient to overcome the magnetic coupling between the magnetic protrusions 112 and the magnets 116. At the same time, a force must also be applied to the lid 110 of the cooler 104 opposing the magnetic attraction between the magnetic protrusions 112 and the cavities 114. Generally, the force applied to the lid of the cooler must be substantially in an opposite direction of the force to pry the cutting board 102 from the lid 110. In one or more scenarios, a weight of the cooler 104 and/or a weight of items held within the cooler 104 may be suitable to “hold the cooler 104 in place” while an upward force is applied to the cutting board 102 to overcome the magnetic coupling and remove the cutting board 102 from the lid 110.

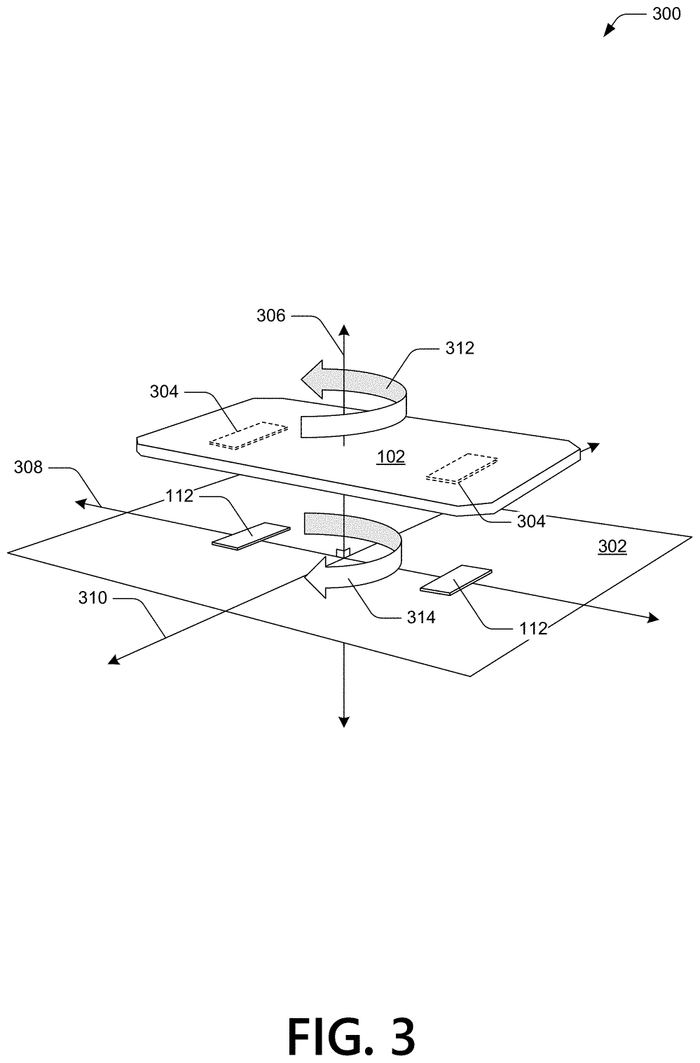

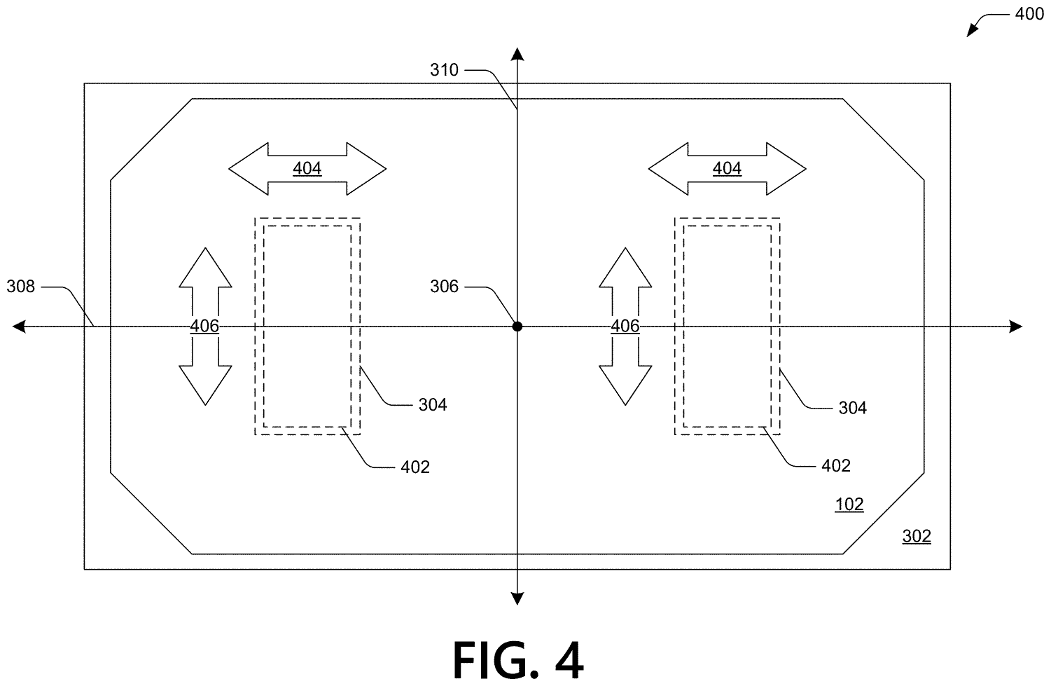

It is to be appreciated that one or more magnets used for the magnetic protrusions 112 and the magnets 116 may be selected so that the magnetic coupling allows the cutting board 102 to be removed relatively easily by a user intentionally attempting to remove the cutting board 102 and also so that the magnetic coupling prevents the cutting board 102 from becoming detached from the lid 110 unintentionally, such as due to wind (e.g., if the cutting board is secured to the lid of the cooler in the back of a moving boat) or due to the cooler 104 falling over. In the context of securing the cutting board 102 mechanically to a surface in relation to one or more axes, consider the following discussion of FIGS. 3 and 4.

FIG. 3 depicts an example 300 of the cutting board, a surface to which the cutting board may be secured with the securing system, and axes around which the securing system mechanically prevents the cutting board from rotating.

The illustrated example 300 includes from FIG. 1 the cutting board 102 and the magnetic protrusions 112. In this example 300, the magnetic protrusions 112 are mounted to surface 302, which may correspond to the lid 110 of the cooler 104 or to some other surface to which the securing system is configured to secure the cutting board 102. In the view depicted in this example 300, the magnetic protrusions 112 of the securing system are visible like in FIG. 2. Also like in FIG. 2, the cavities 114 are not visible in this view because they are occluded by the cutting surface of the cutting board 102—the cavities 114 are disposed on a bottom surface of the cutting board 102. A relative position of the cavities 114 is illustrated by cavity outlines 304, which are depicted as dashed lines in the illustrated example 300.

The illustrated example 300 also includes a first axis 306, a second axis 308, and a third axis 310. The first axis 306 is substantially perpendicular to a plane defined by the surface 302. In one or more implementations, the first axis 306 may also be substantially parallel to a vertical axis of an object corresponding to the surface 302. When the surface 302 corresponds to the lid 110 of the cooler 104, for instance, the first axis 306 may be substantially perpendicular to the lid 110's surface and/or parallel to a vertical axis of the cooler 104. In this example 300, the second axis 308 and the third axis 310 are depicted along the surface 302 and are both substantially perpendicular to the first axis 306. The second axis 308 and the third axis 310 are also depicted substantially perpendicular one to another. In one or more scenarios, the second axis 308 and the third axis 310 may be substantially parallel to a frontal axis and a sagittal axis, respectively, of an object corresponding to the surface 302. These axes are included in this example 300 and in the following example to demonstrate how the securing system mechanically secures the cutting board 102 to a surface.

First rotation representation 312 and second rotation representation 314 represent rotations of the cutting board 102 that are mechanically prevented by physical contact of the magnetic protrusions 112 against a surface of the cavities 114. In particular, the first rotation representation 312 represents a counterclockwise rotation, substantially around the first axis 306, of the cutting board 102 in relation to the surface 302. The second rotation representation 314 represents a clockwise rotation, substantially around the first axis 306, of the cutting board 102 in relation to the surface 302.

When the magnetic protrusions 112 are disposed in the cavities 114, physical contact of the magnetic protrusions 112 against the surface of the cavities 114 substantially prevents the cutting board 102 from rotating relative to the surface 302 both in the direction indicated by the first rotation representation 312 and also in the direction indicated by the second rotation representation 314. In this way, the securing system mechanically secures the cutting board 102 to the surface 302. In addition to preventing such rotation, the securing system also mechanically secures the cutting board 102 to surfaces by preventing other movements orthogonal to the first axis 306, such as shifting the cutting board 102 in relation to a surface. In the context of preventing other movements orthogonal to the first axis 306, consider the following discussion of FIG. 4.

FIG. 4 depicts an example 400 of the cutting board, the surface to which the cutting board may be secured with the securing system, and axes along which the securing system mechanically prevents the cutting board from shifting.

The illustrated example 400 includes the cutting board 102 and the surface 302. In the view depicted in this example 400, the securing system is not visible because its components (e.g., the magnetic protrusions 112, the cavities 114, and the magnets 116) are occluded by a top surface, e.g., the cutting surface, of the cutting board 102. Like in FIG. 3, the relative position of the cavities 114 is illustrated by cavity outlines 304. In addition, a relative position of the magnetic protrusions 112, as disposed in the cavities 114, is illustrated by protrusion outlines 402, which are also depicted in the illustrated example 400 using dashed lines.

This example 400 also includes the first axis 306, the second axis 308, and the third axis 310 from FIG. 3. In contrast to the view of FIG. 3, though, these axes as well as the cutting board 102 and the surface 302 are depicted from a top-down view, such that a viewer “looks down” the first axis 306 at the cutting board 102 and the surface 302. As such, the first axis 306 is depicted as a point in this example 400. In any case, the magnetic protrusions 112 and the cavities 114 are configured to mechanically prevent the cutting board 102 from being shifted in relation to the surface 302.

Side-to-side shifting representations 404 and forward-and-back shifting representations 406 represent shifting movements of the cutting board 102 in relation to the surface 302 that are mechanically prevented by physical contact of the magnetic protrusions 112 against a surface of the cavities 114. In particular, the side-to-side shifting representations 404 represent shifting of the cutting board 102 in relation to the surface 302 in directions (e.g., left or right) that are substantially parallel to the second axis 308. In contrast, the forward-and-back shifting representations 406 represent shifting of the cutting board 102 in relation to the surface 302 in directions (e.g., forward or back) that are substantially parallel to the third axis 310. Although shifting in these directions is depicted in the illustrated example 400, it is to be appreciated that the magnetic protrusions 112 and the cavities 114 prevent shifting in other directions that are substantially orthogonal to the first axis 306 in accordance with the described techniques, such as in a direction that is orthogonal to the first axis 306 and is 45 degrees between the second axis 308 and the third axis 310, e.g. a diagonal shift.

When the magnetic protrusions 112 are disposed in the cavities 114, physical contact of the magnetic protrusions 112 against the surface of the cavities 114 substantially prevents the cutting board 102 from shifting relative to the surface 302 in the directions indicated by the side-to-side shifting representations 404 and the forward-and-back shifting representations 406 and also in other directions that are substantially orthogonal to the first axis 306, e.g., diagonal. By physically preventing such shifts of the cutting board 102, the securing system further mechanically secures the cutting board 102 to the surface 302, e.g., to the lid 110 of the cooler 104 or to some other surface like a truck tailgate.

This example 400 also depicts a gap between the cavity outlines 304 and the protrusion outlines 402. This indicates that in one or more implementations, a shape of the cavities 114 may be similar to a shape of the magnetic protrusions 112, but the shape of the cavities 114 may be slightly larger than the shape of the magnetic protrusions 112. In implementations, surfaces of the magnetic protrusions 112 may substantially contact surfaces of the cavities 114 when the magnetic protrusions 112 are disposed within the cavities 114, i.e., when the cutting board 102 is secured to the surface 302 by the securing system.

Certainly, the illustrated gap may be larger or smaller than a physical gap, if any, between side walls of the magnetic protrusions 112 and walls of surfaces of the cavities 114—the cavity outlines 304 and the protrusion outlines 402 are not drawn to scale. Regardless, a shape of the cavities 114 and a shape of the magnetic protrusions 112 may be complementary—the cavities 114 may have a complementary shape to the magnetic protrusions 112—so that the cavities 114 can receive the magnetic protrusions 112 to secure the cutting board 102 to the surface 302. In one or more implementations, it is to be appreciated that the cavities 114 may be configured so that there is some gap between their surfaces and side walls of the magnetic protrusions 112. This may be so that the cutting board 102 can be pulled away from the surface 302 at an angle (e.g., not parallel to the first axis 306) without catching on the magnetic protrusions 112, thereby loosening or weakening the mounting of the magnetic protrusions 112 to the surface 302.

Having discussed how the securing system magnetically and mechanically secures the cutting board 102 to a surface, e.g., the lid 110 of the cooler 104, consider now the following discussion of a scenario in which the cutting board 102 is secured to the surface.

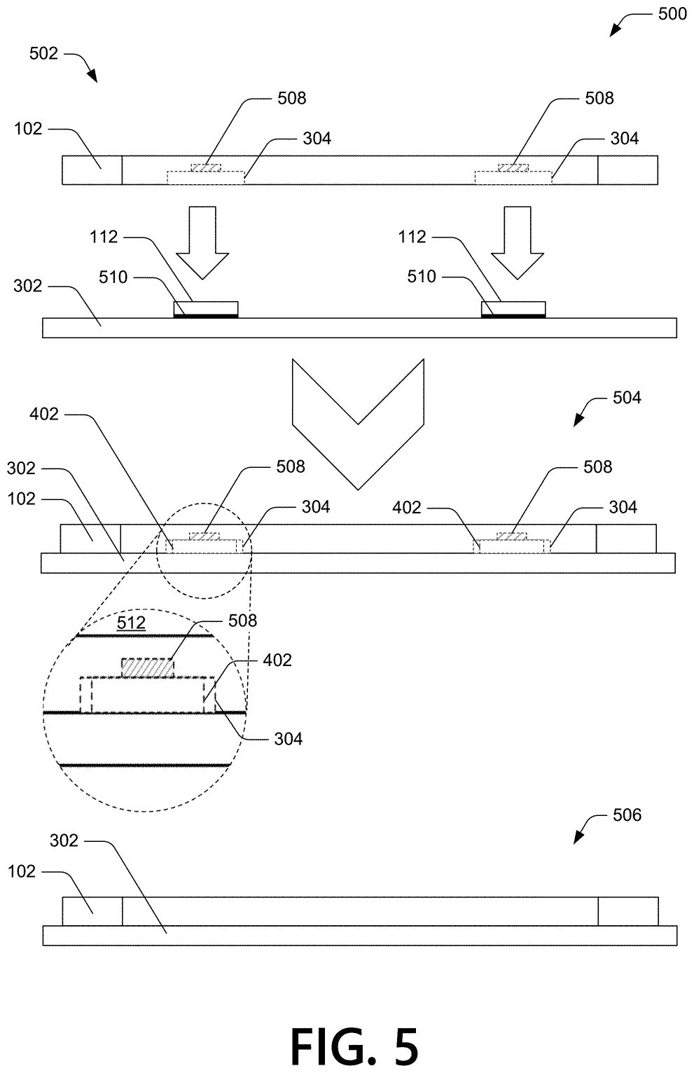

FIG. 5 depicts an example 500 of the cutting board and the surface to which the cutting board may be secured with the securing system in different views, including views depicting that the cutting board occludes the securing system when secured to the surface.

In particular, the illustrated example 500 includes a first stage 502, a second stage 504, and a third stage 506. At the first stage 502, the cutting board 102 is depicted above the surface 302. This represents a point in time when the cutting board 102 is not secured to the surface 302 by the securing system, such as a time when the cutting board 102 is held above the surface 302 before being secured to the surface 302 by the securing system. The first stage 502 includes cavity outlines 304 and also includes embedded magnet outlines 508, which are both illustrated as dashed lines. The embedded magnet outlines 508 have also been illustrated with crosshatching so that they can be visually differentiated from the cavity outlines 304. The cavities 114 and the magnets 116 are represented using the cavity outlines 304 and the embedded magnet outlines 508, respectively, because in the view depicted at the first stage 502, the cavities 114 and the magnets 116 are occluded from view by the cutting board 102, e.g., by one or more materials of the cutting board 102 disposed between the cavities 114 and the magnets 116 and a side of the cutting board 102.

In the view depicted at the first stage 502, the magnetic protrusions 112 are visible as mounted to the surface 302. This example 500 also depicts adhesive 510, which is disposed between the magnetic protrusions 112 and the surface 302. As mentioned above and below, use of the adhesive 510 is one way that the magnetic protrusions 112 may be mounted to a surface, e.g., to the lid 110 of the cooler 104. It is to be appreciated that the magnetic protrusions 112 may be mounted to a surface in other ways, such as using fasteners (e.g., screws) or welding.

Alternatively, the magnetic protrusions 112 may be formed as part of the surface 302. When the surface 302 corresponds to the lid 110 of the cooler 104, for example, the lid 110 may be rotomolded to include magnetic protrusions that are configured to fit within the cavities 114. In another example, where the surface 302 corresponds to a tailgate of a truck, the tailgate may be manufactured or otherwise formed to include such magnetic protrusions, e.g., that are configured to fit within the cavities 114 of the cutting board 102 or of a different accessory that utilizes a securing system in accordance with the described techniques.

At the second stage 504, the cutting board 102 is depicted secured to the surface 302. By way of example, the cutting board 102 may have been lowered from the position depicted at the first stage 502 to the position depicted in the second stage 504. In the position illustrated in the second stage 504, magnetic forces between the magnetic protrusions 112 and the magnets 116 may form a magnetic coupling between those components securing the cutting board 102 to the surface 302.

In the view depicted at the second stage 504, components of the securing system may not be visible. This is because in the view depicted at the second stage 504, the magnetic protrusions 112, the cavities 114, and the magnets 116 are occluded from view by the cutting board 102, e.g., by one or more materials of the cutting board 102 disposed between the magnetic protrusions 112, the cavities 114, and the magnets 116 and a side of the cutting board 102. Accordingly, the magnetic protrusions 112 are represented at the second stage 504 by the protrusion outlines 402. The illustrated example 500 also includes expanded view 512, which simply depicts the cavity outlines 304, the protrusion outlines 402, and the embedded magnet outlines 508 at a higher zoom level.

At the third stage 506, the cutting board 102 and the surface 302 are depicted without the cavity outlines 304, protrusion outlines 402, or the embedded magnet outlines 508. In other words, the third stage 506 may correspond to a same point in time as the second stage 504, but the third stage 506 is illustrated without the cavity outlines 304, protrusion outlines 402, or the embedded magnet outlines 508. This depiction demonstrates how the cutting board 102 may visually occlude the components of the securing system when the cutting board 102 is secured to a surface by the securing system, i.e., the depiction demonstrates how the cutting board 102 visually occludes the magnetic protrusions 112, the cavities 114, and the magnets 116 when secured to the surface 302.

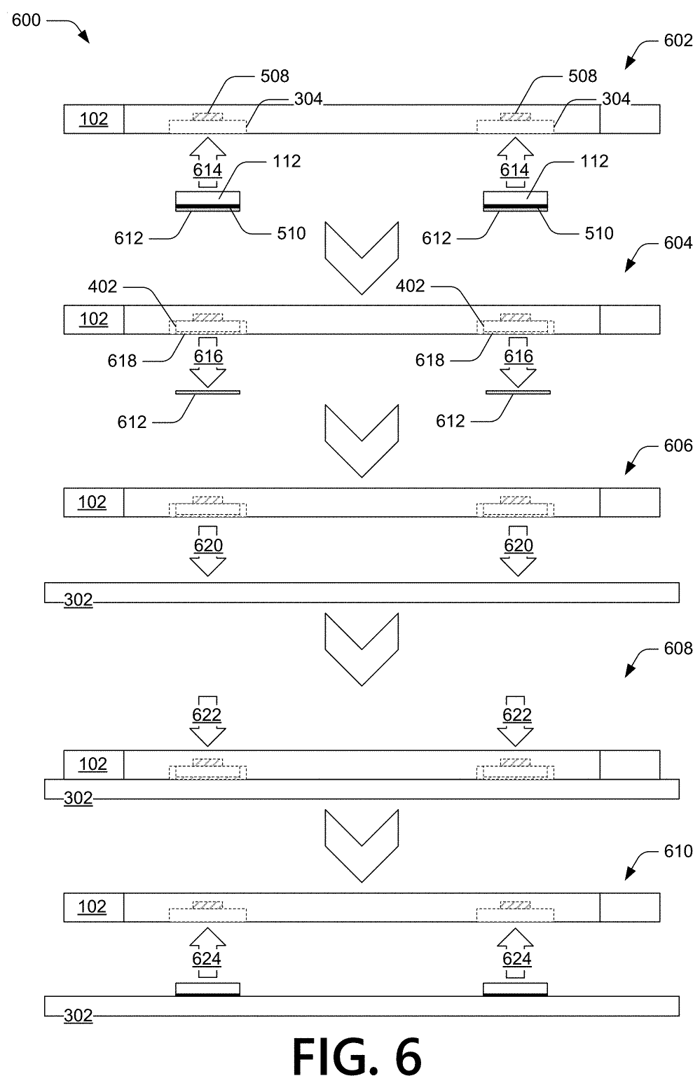

FIG. 6 depicts an example 600 of a scenario in which protrusions of the securing system are mounted to a surface to which the securing system is configured to secure the cutting board.

The illustrated example 600 includes first stage 602, second stage 604, third stage 606, fourth stage 608, and fifth stage 610. At the first stage 602, the example 600 depicts the cutting board 102 and the magnetic protrusions 112 having the adhesive 510. The adhesive 510 is disposed on a surface of the magnetic protrusions 112 that is to be mounted to the surface 302, which is depicted in stages 606-610. At the first stage 602, the adhesive 510 is further depicted with film 612 attached. The film 612 (e.g., an adhesive backing) may be attached to the adhesive 510 before the magnetic protrusions 112 are mounted to the surface 302, so that the magnetic protrusions 112 are not mounted to a surface unintentionally, e.g., due to the adhesive 510 adhering to such a surface. The first stage 602 also includes deposit representations 614, which represent that the magnetic protrusions 112 with the adhesive 510 covered by the film 612 may be deposited into the cavities 114 of the cutting board 102. Since the cavities 114 and the magnets 116 are occluded from view by the cutting board 102, they are represented in the example 600 by the cavity outlines 304 and the embedded magnet outlines 508.

At the second stage 604, the example 600 includes film removal representations 616, which represent that the film 612 is configured to be removed from (e.g., peeled away from) the adhesive 510, exposing the adhesive 510. The film may be removed when a user is ready to mount the magnetic protrusions 112 to the surface 302, for instance. It is to be appreciated that in one or more scenarios, the film 612 may be removed from the adhesive 510 before depositing the magnetic protrusions 112 into the cavities 114 for mounting. As depicted, the magnetic protrusions 112 with the adhesive 510 and the film 612 may also be deposited into the cavities 114, and the film 612 may be subsequently removed for mounting. At the second stage 604, the magnetic protrusions 112 and the adhesive 510 are represented using the protrusion outlines 402 and adhesive outlines 618 because the magnetic protrusions 112 and the adhesive 510 may be occluded from view, entirely or in part, by the cutting board 102.

The third stage 606 is depicted with positioning and lowering representations 620, which represent that the cutting board 102 may be positioned, with the magnetic protrusions 112 magnetically secured to the magnets 116, in order to mount the magnetic protrusions 112 to the surface 302. The positioning and lowering representations 620 also represent that the cutting board 102, with the magnetic protrusions 112 magnetically secured and the adhesive 510 exposed, may be lowered into contact with the surface 302.

The fourth stage 608 is depicted with pressing representations 622. The pressing representations 622 represent that once the cutting board 102 is positioned on the surface 302, a downward force may be applied to the cutting board 102 (e.g., by pressing the cutting board against the surface 302). As the cutting board 102 is pressed, the exposed adhesive 510 may bond with the surface 302, thereby mounting the magnetic protrusions 112 to the surface 302.

The fifth stage 610 is depicted with board removal representations 624. The board removal representations 624 represent that the cutting board 102 may be removed from the surface 302. The board removal representations 624 also represent that after the magnetic protrusions 112 are mounted to the surface 302, the magnetic protrusions 112 are configured to remain mounted when the cutting board 102 is removed. As discussed above and below, the securing system may be configured to secure a cutting board to a lid of a cooler. It is to be appreciated that such a securing system may be used to secure different accessories to different surfaces in accordance with the described techniques. For example, the securing system may be used to secure the cutting board 102 to a tailgate of a truck.

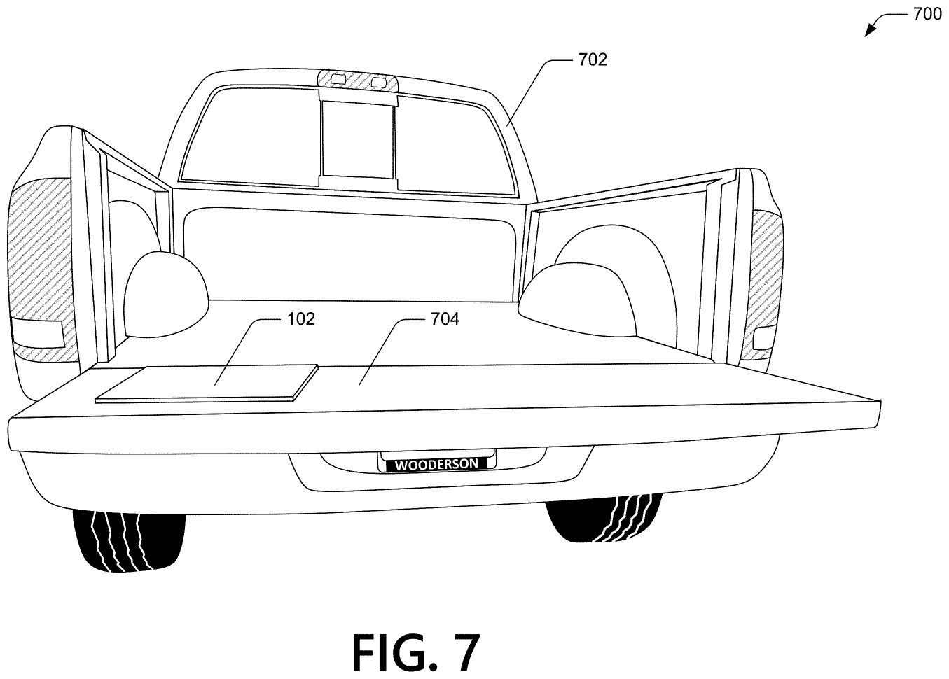

FIG. 7 depicts an example 700 in which the cutting board is secured via a securing system to a different surface from a cooler lid.

The illustrated example 700 depicts the cutting board 102. This example also includes truck 702 having tailgate 704. Here, the cutting board 102 is illustrated disposed on the tailgate 704. In accordance with the described techniques, the cutting board 102 may be secured to the tailgate 704 using the securing system described above and below. In other words, the cutting board 102 may include the cavities 114 and magnets 116 and the magnetic protrusions 112 may be mounted to the tailgate 704.

It is to be appreciated that the securing system may be configured differently than illustrated in one or more implementations. For example, protrusions may be formed as part of the surface to which the securing system secures the cutting board 102 (or other accessory). In the context of FIG. 7, for instance, protrusions may be formed as part of the tailgate 704's surface. Alternatively, the surface to which the cutting board 102 (or other accessory) is secured by the securing system may include the cavities 114 and the cutting board 102 (or other accessory) may include the protrusions. An accessory may be concurrently magnetically and mechanically secured to a surface, using a securing system comprising magnets along with complementary protrusions and cavities, in a variety of ways without departing from the spirit or scope of the techniques described herein. Moreover, the securing system may be occluded from view when the accessory is secured against the surface due to an interior placement of those protrusions and cavities on the contacting surfaces of the accessory and object surface. In addition to these different configurations, the securing system may include different numbers of cavities and protrusions in accordance with the described techniques. In this context, consider the following discussion.

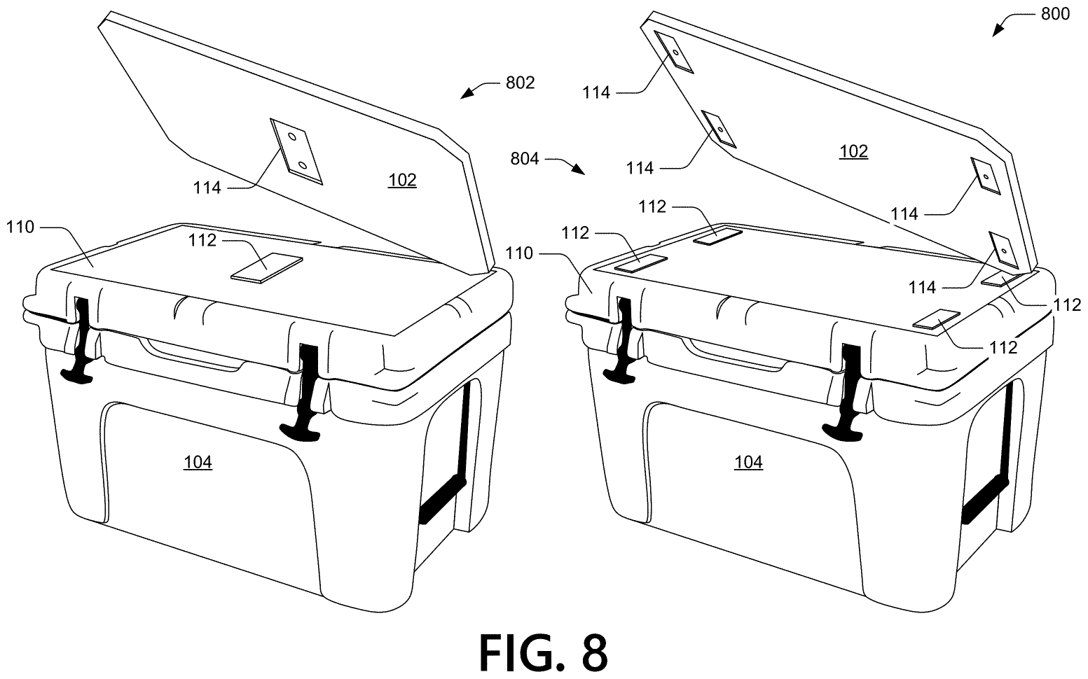

FIG. 8 depicts examples 800 of implementations in which the securing system has different numbers of protrusions and cavities.

The illustrated example 800 depicts a first implementation 802 and a second implementation 804. In the first implementation 802, the securing system is depicted with one protrusion 112, one cavity 114, and the magnets 116 embedded in the one cavity 114. In contrast, the second implementation 804 depicts the securing system having four protrusions 112, four cavities 114, and the magnets 116 embedded in the four cavities 114. It is to be appreciated that the securing system may be configured with any of the number of protrusions and cavities depicted herein (e.g., one, two, or four) or with different numbers of protrusions and cavities than depicted (e.g., three or five or more) without departing from the spirit or scope of the described techniques.

Having discussed exemplary details of the accessory securing system, consider now some examples of procedures to illustrate additional aspects for deployment of the system.

### Example Procedures

This section describes examples of procedures for the accessory securing system. The procedures are shown as a set of blocks that specify operations performed and are not necessarily limited to the orders shown for performing the operations by the respective blocks.

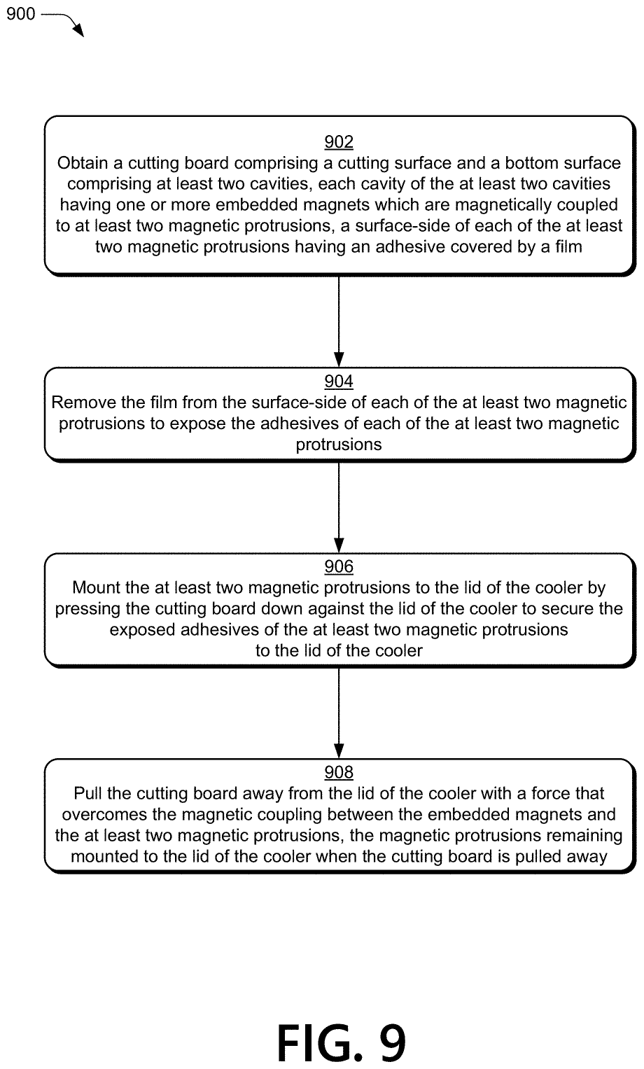

FIG. 9 depicts a procedure 900 in an example implementation in which magnetic protrusions of the securing system are mounted to a lid of a cooler to enable the cutting board to be magnetically and mechanically secured to the lid of the cooler.

A cutting board comprising a cutting surface and a bottom surface comprising at least two cavities is obtained (block 902). In accordance with the principles discussed herein, each cavity of the at least two cavities has one or more embedded magnets which are magnetically coupled to at least two magnetic protrusions, and a mounting-surface side of each of the at least two magnetic protrusions has an adhesive covered by a film By way of example, cutting board 102 includes cavities 114 and magnets 116 embedded in the cavities 114, which are magnetically coupled to magnetic protrusions 112. An adhesive 510 may be applied to a mounting-surface side of the magnetic protrusions 112, and prior to mounting the magnetic protrusions 112 to the lid 110 of the cooler 104, the adhesive 510 may be covered with a film 612 (e.g., an adhesive backing) so that the magnetic protrusions 112 are not mounted to a surface unintentionally, e.g., due to the adhesive 510 adhering to such a surface.

The film is removed from the mounting-surface side of each of the at least two magnetic protrusions to expose the adhesives of each of the at least two magnetic protrusions (block 904). By way of example, the film 612 is removed from (e.g., peeled away from) the mounting-surface side of the at least two magnetic protrusions 112 to expose the adhesives 510. The film 612 may be removed when a user is ready to mount the magnetic protrusions 112 to the lid 110 of the cooler 104. It is to be appreciated that in one or more scenarios, a user may remove the film 612 before depositing the magnetic protrusions 112 into the cavities 114 for mounting. As depicted, a user may also deposit the magnetic protrusions 112 with the adhesive 510 and the film 612 into the cavities 114, and then subsequently remove the film 612 for mounting.

The at least two magnetic protrusions are mounted to the lid of a cooler by pressing the cutting board down against the lid of the cooler to secure the exposed adhesives of the at least two magnetic protrusions to the lid of the cooler (906). By way of example, a user may position the cutting board 102, with the magnetic protrusions 112 magnetically secured to the magnets 116, in order to mount the magnetic protrusions 112 to the surface 302 (e.g., the lid of the cooler). The positioning and lowering representations 620 represent that the user may lower the cutting board 102, with the magnetic protrusions 112 magnetically secured and the adhesive 510 exposed, into contact with the surface 302. Once the cutting board 102 is positioned on the surface 302, a use may apply a downward force to the cutting board 102 (e.g., by pressing the cutting board against the surface 302). As the cutting board 102 is pressed, the exposed adhesive 510 may bond with the surface 302, thereby mounting the magnetic protrusions 112 to the surface 302.

The cutting board is pulled away from the lid of the cooler with a force that overcomes the magnetic coupling between the embedded magnets and the at least two magnetic protrusions (block 908). In accordance with the principles discussed herein, the magnetic protrusions remain mounted to the lid of the cooler when the cutting board is pulled away. By way of example, the board removal representations 624 represent that a user may remove the cutting board from the surface 302. The board removal representations 624 also represent that after the magnetic protrusions 112 are mounted to the surface 302, the magnetic protrusions 112 are configured to remain mounted when the cutting board 102 is removed. In other words, the bond of the adhesive to the surface of the lid of the cutting board 102 is stronger than the complementary magnetic force forming the coupling between the magnetic protrusions 112 and the magnets 116. This enables the cutting board 102 to be removed (e.g., pulled off) of the lid 110 of the cooler 104 without removing the magnetic protrusions 112 from the lid 110—the magnetic protrusions 112 are configured to remain mounted on the lid 110 after the adhesive bonds the magnetic protrusions 112 to the lid 110.

### CONCLUSION

Although aspects of an accessory securing system have been described in language specific to structural features and/or methods, it is to be understood that the appended claims are not necessarily limited to the specific features or methods described. Rather, the specific features and methods are disclosed as example implementations of an accessory securing system. Further, various different examples are described, and it is to be appreciated that each described example can be implemented independently or in connection with one or more other described examples.

What is claimed is:

1. A cutting board comprising:
a cutting surface; and
a bottom surface comprising at least two cavities, each cavity of the at least two cavities having one or more embedded magnets and configured to receive a magnetic protrusion of at least two magnetic protrusions mounted to a lid of a cooler, the at least two cavities and the at least two magnetic protrusions forming a securing system to mechanically and magnetically secure the cutting board to the lid of the cooler.

2. The cutting board as described in claim 1, wherein each cavity of the at least two cavities has a complementary shape to each of the at least two magnetic protrusions.

3. The cutting board as described in claim 1, wherein each magnetic protrusion of the at least two magnetic protrusions is configured to physically contact a surface of each cavity of the at least two cavities to mechanically secure the cutting board to the lid of the cooler when the at least two magnetic protrusions are disposed within the at least two cavities.

4. The cutting board as described in claim 3, wherein the magnetic protrusions may contact one or more walls of the cavities such that the contact prevents further movement of the cutting board and the lid of the cooler, relative one to another.

5. The cutting board as described in claim 1, wherein the one or more embedded magnets within each cavity of the at least two cavities create a magnetic coupling with each respective magnetic protrusion of the at least two magnetic protrusions to magnetically secure the cutting board to the lid of the cooler when the at least two magnetic protrusions are disposed within the at least two cavities.

6. The cutting board as described in claim 5, wherein the cutting board is removable via a force that is in an opposite direction of a force of the magnetic coupling and that is sufficient to overcome the magnetic coupling.

7. The cutting board as described in claim 1, wherein each magnetic protrusion of the at least two magnetic protrusions is secured to the lid of the cooler via an adhesive.

8. The cutting board as described in claim 1, wherein the at least two cavities and the at least two magnetic protrusions of the securing system are hidden from view when the at least two magnetic protrusions are disposed within the at least two cavities to secure the cutting board to the lid of the cooler.

9. The cutting board as described in claim 1, wherein the securing system is configured to secure the cutting board to the lid of the cooler when the lid of the cooler is opened.

10. The cutting board as described in claim 1, wherein each magnetic protrusion of the at least two magnetic protrusions is secured to the lid of the cooler via at least one screw.

11. A system comprising:
an accessory comprising a top surface and a bottom surface;
a separate object; and
a securing system comprising a first securing portion positioned on the bottom surface of the accessory and a second securing portion positioned on the separate object, the securing system configured to mechanically and magnetically secure the bottom surface of the accessory to the separate object.

12. The system as described in claim 11, wherein the securing system comprises one or more magnetic protrusions, one or more cavities to receive the one or more magnetic protrusions, and one or more magnets embedded within each of the one or more cavities.

13. The system as described in claim 12, wherein each magnetic protrusion of the one or more magnetic protrusions is configured to physically contact a surface of a respective cavity of the one or more cavities to mechanically secure the accessory to the separate object when the one or more magnetic protrusions are disposed within the one or more cavities.

14. The system as described in claim 12, wherein the one or more embedded magnets within each cavity of the one or more cavities create a magnetic coupling with a respective magnetic protrusion of the one or more magnetic protrusions to magnetically secure the accessory to the separate object when the one or more magnetic protrusions are disposed within the one or more cavities.

15. The system as described in claim 12, wherein the first securing portion positioned on the bottom surface of the accessory includes the one or more magnetic protrusions, and wherein the second securing portion positioned on the separate object includes the one or more cavities and the embedded magnets.

16. The system as described in claim 12, wherein the first securing portion positioned on the bottom surface of the accessory includes the one or more cavities and the embedded magnets, and wherein the second securing portion positioned on the separate object includes the one or more magnetic protrusions.

17. The system of claim 11, wherein the accessory comprises a cutting board, and wherein the top surface comprises a cutting surface of the cutting board.

18. The system of claim 11, wherein the accessory comprises a seat cushion, and wherein the separate object comprises a lid of a cooler.

19. The system of claim 11, wherein the separate object comprises a lid of a cooler.

20. A method for mounting a cutting board to a lid of a cooler, the method comprising:
obtaining a cutting board comprising a cutting surface and a bottom surface comprising at least two cavities, each cavity of the at least two cavities having one or more embedded magnets which are magnetically coupled to at least two magnetic protrusions, a mounting-surface side of each of the at least two magnetic protrusions having an adhesive covered by a film;
removing the film from the mounting-surface side of each of the at least two magnetic protrusions to expose the adhesive of each of the at least two magnetic protrusions;
mounting the at least two magnetic protrusions to the lid of the cooler by pressing the cutting board down against a lid of a cooler to secure the exposed adhesive of the at least two magnetic protrusions to the lid of the cooler; and
pulling the cutting board away from the lid of the cooler with a force that overcomes the magnetic coupling between the embedded magnets and the at least two magnetic protrusions, the magnetic protrusions remaining mounted to the lid of the cooler when the cutting board is pulled away.
